(19) United States
(12) Patent Application Publication
(10) Pub. No.: US 2023/0031624 A1
(43) Pub. Date: Feb. 2, 2023

(54) METHODS, SYSTEMS, APPARATUSES AND DEVICES FOR FACILITATING CAPITALIZING ON A PORTFOLIO OF PRE-SELECTED MULTI LEVEL MARKETING COMPANIES

(71) Applicant: Jose Contreras, Coral Springs, FL (US)

(72) Inventor: Jose Contreras, Coral Springs, FL (US)

(21) Appl. No.: 17/780,914

(22) PCT Filed: Sep. 14, 2021
(86) PCT No.: PCT/US21/50315

§ 371 Date: May 27, 2022

Related U.S. Application Data
(60) Provisional application No. 63/077,924, filed on Sep. 14, 2020.

(51) Int. Cl. G06Q 30/02; G06Q 30/06

(52) U.S. Cl. CPC G06Q 30/0214; G06Q 30/0635; G06Q 30/0609

(57) ABSTRACT

A method for facilitating capitalizing on a portfolio of pre-selected multi-level marketing companies is provided. The method may include receiving a user credential, generating a user account, retrieving at least one of a company data and a training support data, transmitting at least one of the company data and the training support data, receiving a first selected company data, receiving a first purchase order data, transmitting the first purchase order data, receiving a first transaction profit data, analyzing at least one of the first transaction profit data and the company data, transmitting a purchase request, receiving a second selected company data, transmitting the second purchase order data, receiving a second transaction profit data, analyzing the first transaction profit data and the second transaction profit data and transmitting at least one of the first transaction profit data, the second transaction profit data, and the subscription alert.

### FIELD OF THE INVENTION

Generally, the present disclosure relates to the field of data processing. More specifically, the present disclosure relates to methods, systems, apparatuses, and devices for facilitating capitalizing on a portfolio of pre-selected Multi-Level Marketing companies.

### BACKGROUND OF THE INVENTION

Existing techniques for facilitating capitalizing on a portfolio of pre-selected Multi-Level Marketing companies are deficient with regard to several aspects. For instance, current technologies do not facilitate a user to reinvest profit from a first Multi-Level Marketing (MLM) company into one or more MLM companies. Furthermore, current technologies do not facilitate in providing training videos and support for educating new users about an MLM industry. Moreover, current technologies do not facilitate in providing the user with a progressive membership schedule that charges the user basis the profit earned by the user.

Therefore, there is a need for improved methods, systems, apparatuses, and devices for facilitating capitalizing on a portfolio of pre-selected Multi-Level Marketing companies that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating capitalizing on a portfolio of pre-selected multi-level marketing companies may include a step of receiving, using a communication device, one or more user credential from one or more user devices associated with one or more user, in accordance with some embodiments. Further, the method may include a step of generating, using a processing device, a user account based on the receiving. Further, the method may include a step of retrieving, using a storage device, one or more of one or more pre-selected portfolio company data and one or more training support data. Further, the method may include a step of transmitting, using the communication device, one or more of the one or more pre-selected portfolio company data and the one or more training support data to the one or more user devices. Further, the method may include a step of receiving, using the communication device, a first selected company data of the one or more pre-selected portfolio company data from the one or more user devices. Further, the method may include a step of receiving, using the communication device, a first purchase order data associated with a first product of the first selected company data from the one or more user devices. Further, the method may include a step of transmitting, using the communication device, the first purchase order data to a first server associated with the first selected company data. Further, the method may include a step of receiving, using the communication device, a first transaction profit data associated with the first purchase order data from the first server. Further, the method may include a step of analyzing, using the processing device, one or more of the first transaction profit data and the one or more pre-selected portfolio company data to generate a purchase request. Further, the method may include a step of transmitting, using the communication device, the purchase request to the one or more user devices. Further, the method may include a step of receiving, using the communication device, a second selected company data of the one or more pre-selected portfolio company data and a second purchase order data from the one or more user devices. Further, the method may include a step of transmitting, using the communication device, the second purchase order data associated with a second product of the second selected company data to a second server associated with the second selected company data. Further, the method may include a step of receiving, using the communication device, a second transaction profit data associated with the second purchase order data from the second server. Further, the method may include a step of analyzing, using the processing device, the first transaction profit data and the second transaction profit data to generate a subscription alert. Further, the method may include a step of transmitting, using the communication device, one or more of the first transaction profit data, the second transaction profit data, and the subscription alert to the one or more user devices.

Further disclosed herein is a system for facilitating capitalizing on a portfolio of pre-selected multi-level marketing companies, in accordance with some embodiments. The system may include a communication device, a processing device, and a storage device. Further, the communication device may be configured for performing a step of receiving one or more user credential from one or more user devices associated with one or more user. Further, the communication device may be configured for performing a step of transmitting one or more of one or more pre-selected portfolio company data and one or more training support data to the one or more user devices. Further, the communication device may be configured for performing a step of receiving a first selected company data of the one or more pre-selected portfolio company data from the one or more user devices. Further, the communication device may be configured for performing a step of receiving a first purchase order data associated with a first product of the first selected company data from the one or more user devices. Further, the communication device may be configured for performing a step of transmitting the first purchase order data to a first server associated with the first selected company data. Further, the communication device may be configured for performing a step of receiving a first transaction profit data associated with the first purchase order data from the first server. Further, the communication device may be configured for performing a step of transmitting a purchase request to the one or more user devices. Further, the communication device may be configured for performing a step of receiving a second selected company data of the one or more pre-selected portfolio company data and a second purchase order data from the one or more user devices. Further, the communication device may be configured for performing a step of transmitting the second purchase order data associated with a product of the second selected company data to a second server associated with the second selected company data. Further, the communication device may be configured for performing a step of receiving a second transaction profit data associated with the second purchase order data from the second server. Further, the communication device may be configured for performing a step of transmitting, using the communication device, one or more of the first transaction profit data, the second transaction profit data, and a subscription alert to the one or more user devices. Further, the processing device may be configured for performing a step of generating a user account based on the receiving of the user credentials. Further, the processing device may be configured for performing a step of analyzing one or more of the first transaction profit data and the one or more pre-selected portfolio company data to generate the purchase request. Further, the processing device may be configured for performing a step of analyzing the first transaction profit data and the second transaction profit data to generate the subscription alert. Further, the storage device may be configured for performing a step of retrieving one or more of the one or more pre-selected portfolio company data and the one or more training support data.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating capitalizing on a portfolio of pre-selected Multi-Level Marketing companies, in accordance with some embodiments.

FIG. 3 is a flowchart of a method for facilitating capitalizing on a portfolio of pre-selected Multi-Level Marketing companies, in accordance with some embodiments.

FIG. 4 is a flowchart of a method associated with a validation procedure for a new member, in accordance with some embodiments.

FIG. 5 is a table associated with a new member, in accordance with some embodiments.

FIG. 6 is a table associated with an upline validation section, in accordance with some embodiments.

FIG. 7 is a flowchart of a method associated with a sponsor mismatch procedure, in accordance with some embodiments.

FIG. 8 is a flowchart of a method for reinvestment of profit from a first Multi-Level Marketing (MLM) company into one or more MLM companies, in accordance with some embodiments.

FIG. 9 is a flow diagram of a method for reinvestment of profit from the first Multi-Level Marketing (MLM) company into a second Multi-Level Marketing company, in accordance with some embodiments.

FIG. 10 is a flow diagram of a method for reinvestment of profits from the first Multi Level Marketing (MLM) company and the second Multi-Level Marketing company into a third MLM company, in accordance with some embodiments.

FIG. 11 is a flow diagram of a method for reinvestment of profits from the first Multi-Level Marketing (MLM) company, the second Multi-Level Marketing company, the third MLM company into a user bank, a fourth MLM company, and a fifth MLM company, in accordance with some embodiments.

FIG. 12 is a flow diagram of a method for reinvestment of profits from the first Multi Level Marketing (MLM) company, the second Multi-Level Marketing company, the third MLM company, the fourth MLM company, the fifth MLM company into the user bank, a sixth MLM company, a seventh MLM company, and an eight MLM company, in accordance with some embodiments.

FIG. 13 is a flow diagram of a method for reinvestment of profits from the first Multi-Level Marketing (MLM) company, the second Multi-Level Marketing company, the third MLM company, the fourth MLM company, the fifth MLM company, the sixth MLM company, the seventh MLM company, the eight MLM company into the user bank, a ninth MLM company, and a tenth MLM company, in accordance with some embodiments.

FIG. 14 is a flow diagram of a method for reinvestment of profits from the first Multi Level Marketing (MLM) company, the second Multi-Level Marketing company, the third MLM company, the fourth MLM company, the fifth MLM company, the sixth MLM company, the seventh MLM company, the eight MLM company, the ninth MLM company, and the tenth MLM company into the user bank, in accordance with some embodiments.

FIG. 15 is a flowchart associated with a schema related to a method for facilitating capitalizing on a portfolio of pre-selected Multi-Level Marketing companies, in accordance with some embodiments.

FIG. 16 is a continuation flowchart of FIG. 15.

FIG. 17 is a continuation flowchart of FIGS. 15 and 16.

FIG. 18 is a continuation flowchart of FIGS. 15, 16 and 17.

FIG. 19 is a continuation flowchart of FIGS. 15, 16, 17 and 18.

FIG. 20 is a flow chart of a method for facilitating capitalizing on a portfolio of pre-selected Multi-Level Marketing companies, in accordance with some embodiments.

FIG. 21 is a continuation flow chart of FIG. 20.

FIG. 22 is the continuation flow chart of FIG. 21.

FIG. 23 is a flow chart of a method for facilitating capitalizing on a portfolio of pre-selected Multi-Level Marketing companies, in accordance with further embodiments.

FIG. 24 is a flow chart of a method for facilitating capitalizing on a portfolio of pre-selected Multi-Level Marketing companies, in accordance with further embodiments.

FIG. 25 is a flow chart of a method for facilitating capitalizing on a portfolio of pre-selected Multi-Level Marketing companies, in accordance with further embodiments.

FIG. 26 is a block diagram of a system for facilitating capitalizing on the portfolio of pre-selected Multi-Level Marketing companies, in accordance with some embodiments.

FIG. 27 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of facilitating capitalizing on a portfolio of pre-selected Multi-Level Marketing companies, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g., Windows, Mac OS, Unix, Linux, Android, etc.) in order to provide a user interface (e.g., GUI, touchscreen-based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding, and decoding. Further, the server computer may include a communication device configured for communicating with one or more external devices. The one or more external devices may include, for example, but are not limited to, a client device, a third-party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data fingerprinting, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker, and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g., transmitting and/or receiving) with one or more sensor devices and/or one or more actuators in order to perform authentication. For example, the one or more steps may include receiving, using the communication device, the secret human readable data from an input device such as, for example, a keyboard, a keypad, a touchscreen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g., initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods and systems for facilitating capitalizing on a portfolio of pre-selected Multi-Level Marketing companies. Further, the present disclosure is a membership-based system designed to capitalize on the Multi-Level Marketing (MLM) industry. Further, the present disclosure describes a software platform, which provides step-by-step access (as milestones) to our selected portfolio of companies, as well as training and support. The software platform may include, for all intent and purposes, an MLM hub. Further, the software platform does not make any payments out to the members. Further, the software platform will only receive monthly membership dues. Further, the membership schedule is progressive and directly relational to the member's income; as each member grows within the system, and he/she is making enough income to join the next company so will the membership. The software platform is setting it up as a reciprocal or rather, symbiotic relationship. Further, the software platform may include a milestone-based system in which members use the income they generate from one or more of the portfolio companies to fund entry into the subsequent companies. Further, the software platform may provide the members with a step-by-step, low-cost, low-risk system that will allow folks with very little knowledge of sales or marketing to accomplish what only professional marketers can accomplish which is to capitalize on a (pre-selected) portfolio of MLM companies, hence creating multiple streams of passive income, generated from a very small team (3×5 matrix where the members only need to select 3 like-minded individuals) by proposing that it is much easier to produce $500 in residual income from 10 MLM companies than it is to generate $5 k from a single company.

Further, the present disclosure may include a re-invest-from-profits system for the MLM industry to create income from a portfolio of MLM companies without any special skills. Further, the initial portfolio of companies has been carefully selected—for several reasons—to maximize and expedite ROI for our members. The MLM industry has been around for over 60 years and is regulated by the FTC. The MLM industry is a thriving industry with billions in sales vs an extremely high percentage of people who do not make any significant income. Further, in the MLM industry, the failure rate is somewhere in the 90 percentiles: most people join, give a shot, realize they can't do it, give up 90 days later or so and call it a scam. This means that those who actually make money have a very specific skill set but have to be consistently recruiting new members as others drop out.

Further, the software platform may include low upfront cost, low monthly cost, low risk. Instead of fishing for people who would be interested in your idea, due to the low cost and upside of the business plan, the user actually gets to select 3 individuals that the user already knows and who have a trusting relationship with the user. Further, the software platform may need very little salesmanship. Further, the software platform is a warm market based system, designed for people to present to people in a conversational manner. No intimidating social media marketing is needed. Further, the software platform may be associated with rapid ROI\High retention. Once members reach their monthly investment in income, there will be very little reason for the user to leave. further, the members will be capitalizing on the millions of dollars already invested by the selected portfolio of MLM companies, all of which are currently in operation, some of them for decades. Further, the software platform may be easy to understand. Further, the software platform may provide training and support. Further, the training and videos may be professionally made animated infographics. Further, the user may not need to run SEO campaigns, digital campaigns, FB marketing, etc. Further, the amount of time needed by members should be very little, compare to regular MLM companies, because the members do not have to attend conferences, webinars, etc.

Over 90% of people try the MLM industry for about 90 days and then quit. Further, the entry costs are between $250 & $1500 and monthly auto ship costs are between $100 & 300. Further, the type of people who succeed may include professional MLM Marketers and professional online marketers. Due to the failure rate in the regular MLM, the professional MLM Marketers have to replenish quitting members again and again. Further, in the regular MLM, face to face visits, an invitation to meetings may be required. Further, the regular MLM requires drive, time, money, and sales skills. Further, the regular MLM may offer a very little opportunity of creating multiple streams of income. Further, in the regular MLM industry, the vast majority of income comes from one-time bonuses and very little residual.

Further, due to the failure rate, the professional online marketer has to replenish quitting members again and again. Further, the professional online marketer may not require Face to face visits. Further, the professional online marketer must acquire knowledge in digital marketing. Further, the professional online marketer may have a steep learning curve. Further, regular MLM for the professional online marketer may be time consuming and complex. Further, the professional online marketer must build large email lists that he/she has to blast monthly for each campaign. If promoting more than one company, these digital campaigns have to run for each company individually, compounding costs. Further, there may be a vast majority of income comes from one-time bonuses and very little residual for the professional online marketer.

Unless the user is a professional MLM or Online Marketer, it is highly unlikely that the user will succeed in creating residual income.

Further, the software platform may be associated with progressive membership. Further, the progressive membership schedule guarantees to our members that if the members do not reach an income milestone, the user may not be charged for an upgraded membership. If the system works our members earn and upgrade.

Further, the software platform does not pay out commissions. Further, the software platform may be a closed system, where members are called by invitation only. Further, the software platform may be conversation based. Further, the software platform may be designed for the retention of the members. Further, the user's requirements for the software platform may include US as only location, US Address—no PO box, members must be of legal age, SSN or similar, US bank account and VISA or MC.

Further, the software platform may include a validation procedure. As powerful as the idea is, making it work is quite the task. Further, the software platform may do not have access to the full structure of each of portfolio companies (Group of selected MLM companies) and in order for downline flow to be maintained across all the portfolio companies, a verification process is needed. Further, the downline may include the user's referrals, the user's referral's referrals, etc. As new members sign in under existing users in the portfolio companies, the new members will be taken to their sponsor's replicable website (the existing user website) and after the purchase is made the new member will be given a unique replicable website. There could be a typo (mistake) or the member could have an existing replicable website that does not come from the existing upline (a cheater) which would neutralize or cheat those upstream from him/her. Further, the URL validation section may include a field in the software platform's back office where users enter each portfolio company's replicable website. The validation system would inform his upline (× levels up) and request that each of them validate that the URL is valid in the portfolio company within a specific timeframe (72 hrs.). If any of the upline members fail to validate in time and/or any of the upline members do not validate, the management team will get involved. Further, the upline may include the user's sponsor, the user's sponsor's sponsor, the user's sponsor's sponsor's sponsor, etc. Further, the replicable website may include a website unique to each user provided by each MLM company after the purchase is made.

According to some embodiments, a method for facilitating capitalizing on a portfolio of pre-selected Multi-Level Marketing companies is disclosed. Accordingly, the method may include a step of receiving, using a communication device, at least one user credential from at least one user device associated with at least one user. Further, the method may include a step of generating, using a processing device, a user account based on the receiving. Further, the method may include a step of retrieving, using a storage device, at least one of at least one pre-selected portfolio company data and at least one training support data. Further, the method may include a step of transmitting, using the communication device, at least one of the at least one pre-selected portfolio company data and the at least one training support data to the at least one user device. Further, the method may include a step of receiving, using the communication device, a first selected company data of the at least one pre-selected portfolio company data from the at least one user device. Further, the method may include a step of receiving, using the communication device, a first purchase order data associated with a product of the first selected company data from the at least one user device. Further, the method may include a step of transmitting, using the communication device, the first purchase order data to a first server associated with the first selected company data. Further, the method may include a step of receiving, using the communication device, a first transaction profit data associated with the first purchase order data from the first server. Further, the method may include a step of analyzing, using the processing device, at least one of the first transaction profit data and the at least one pre-selected portfolio company data to generate a purchase request. Further, the method may include a step of transmitting, using the communication device, the purchase request to the at least one user device. Further, the method may include a step of receiving, using the communication device, a second selected company data of the at least one pre-selected portfolio company data and a second purchase order data from the at least one user device. Further, the method may include a step of transmitting, using the communication device, the second purchase order data associated with a product of the second selected company data to a second server associated with the second selected company data. Further, the method may include a step of receiving, using the communication device, a second transaction profit data associated with the second purchase order data from the second server. Further, the method may include a step of analyzing, using the processing device, the first transaction profit data and the second transaction profit data to generate a subscription alert. Further, the method may include a step of transmitting, using the communication device, at least one of the first transaction profit data, the second transaction profit data, and the subscription alert to the at least one user device.

According to some aspects, a system for facilitating capitalizing on a portfolio of pre-selected Multi-Level Marketing companies is disclosed. Accordingly, the system may include a communication device, a processing device, and a storage device.

Further, the communication device is configured for receiving at least one user credential from at least one user device associated with at least one user. Further, the communication device is configured for transmitting at least one of at least one pre-selected portfolio company data and at least one training support data to the at least one user device. Further, the communication device is configured for receiving a first selected company data of the at least one pre-selected portfolio company data from the at least one user device. Further, the communication device is configured for receiving a first purchase order data associated with a product of the first selected company data from the at least one user device. Further, the communication device is configured for transmitting the first purchase order data to a first server associated with the first selected company data. Further, the communication device is configured for receiving a first transaction profit data associated with the first purchase order data from the first server. Further, the communication device is configured for transmitting a purchase request to the at least one user device. Further, the communication device is configured for receiving a second selected company data of the at least one pre-selected portfolio company data and a second purchase order data from the at least one user device. Further, the communication device is configured for transmitting the second purchase order data associated with a product of the second selected company data to a second server associated with the second selected company data. Further, the communication device is configured for receiving a second transaction profit data associated with the second purchase order data from the second server. Further, the communication device is configured for transmitting, using the communication device, at least one of the first transaction profit data, the second transaction profit data, and a subscription alert to the at least one user device.

Further, the processing device is configured for generating, using a processing device, a user account based on the receiving of the user credentials. Further, the processing device is configured for analyzing, using the processing device, at least one of the first transaction profit data and the at least one pre-selected portfolio company data to generate the purchase request. Further, the processing device is configured for analyzing, using the processing device, the first transaction profit data and the second transaction profit data to generate the subscription alert.

Further, the storage device is configured for retrieving, using a storage device, at least one of the at least one pre-selected portfolio company data and the at least one training support data.

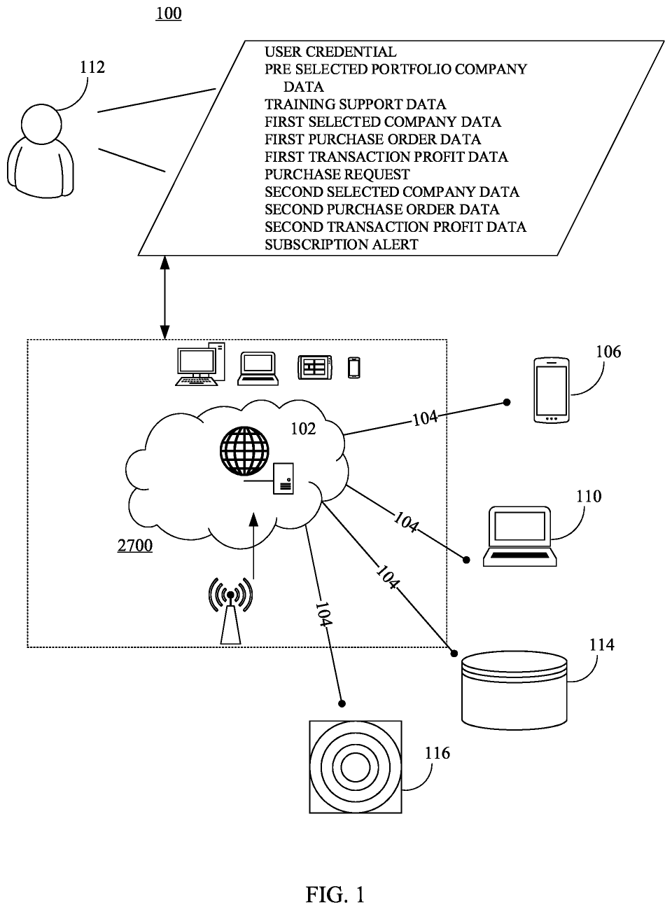

FIG. 1 is an illustration of an online platform 100 consistent with various embodiments of the present disclosure. By way of non-limiting example, the online platform 100 to enable facilitating capitalizing on a portfolio of pre-selected Multi-Level Marketing companies may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 2700.

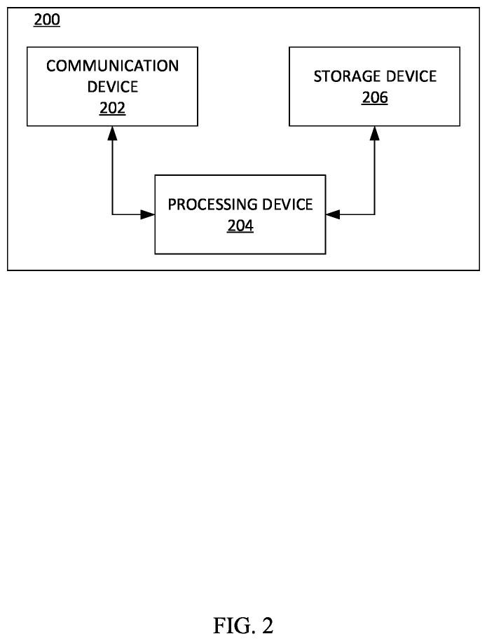

FIG. 2 is a block diagram of a system 200 for facilitating capitalizing on a portfolio of pre-selected Multi-Level Marketing companies, in accordance with some embodiments. Accordingly, the system 200 may include a communication device 202, a processing device 204, and a storage device 206.

Further, the communication device 202 is configured for receiving at least one user credential from at least one user device associated with at least one user. Further, the communication device 202 is configured for transmitting at least one of at least one pre-selected portfolio company data and at least one training support data to the at least one user device. Further, the communication device 202 is configured for receiving a first selected company data of the at least one pre-selected portfolio company data from the at least one user device. Further, the communication device 202 is configured for receiving a first purchase order data associated with a product of the first selected company data from the at least one user device. Further, the communication device 202 is configured for transmitting the first purchase order data to a first server associated with the first selected company data. Further, the communication device 202 is configured for receiving a first transaction profit data associated with the first purchase order data from the first server. Further, the communication device 202 is configured for transmitting a purchase request to the at least one user device. Further, the communication device 202 is configured for receiving a second selected company data of the at least one pre-selected portfolio company data and a second purchase order data from the at least one user device. Further, the communication device 202 is configured for transmitting the second purchase order data associated with a product of the second selected company data to a second server associated with the second selected company data. Further, the communication device 202 is configured for receiving a second transaction profit data associated with the second purchase order data from the second server. Further, the communication device 202 is configured for transmitting, using the communication device 202, at least one of the first transaction profit data, the second transaction profit data, and a subscription alert to the at least one user device.

Further, the processing device 204 is configured for generating a user account based on the receiving of the user credentials. Further, the processing device 204 is configured for analyzing at least one of the first transaction profit data and the at least one pre-selected portfolio company data to generate the purchase request. Further, the processing device 204 is configured for analyzing the first transaction profit data and the second transaction profit data to generate the subscription alert.

Further, the storage device 206 is configured for retrieving at least one of the at least one pre-selected portfolio company data and the at least one training support data.

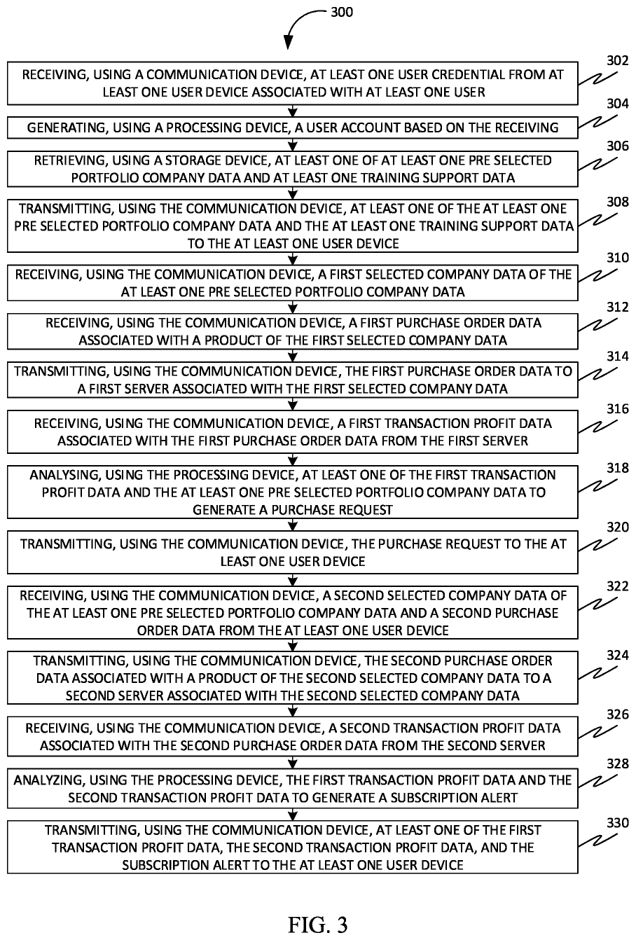

FIG. 3 is a flowchart of a method 300 for facilitating capitalizing on a portfolio of pre-selected Multi-Level Marketing companies, in accordance with some embodiments. Accordingly, at 302, the method 300 may include a step of receiving, using a communication device, at least one user credential from at least one user device associated with at least one user. Further, the at least one user credential may be associated with the at least one user. Further, the at least one user may include an individual, an institution, an organization. Further, the at least one user credential may include at least one of a name, an address, an email address, etc. Further, the at least one user device may include a smartphone, a tablet, a laptop, a personal computer, and so on.

Further, at 304, the method 300 may include a step of generating, using a processing device, a user account based on the receiving.

Further, at 306, the method 300 may include a step of retrieving, using a storage device, at least one of at least one pre-selected portfolio company data and at least one training support data.

Further, at 308, the method 300 may include a step of transmitting, using the communication device, at least one of the at least one pre-selected portfolio company data and the at least one training support data to the at least one user device. Further, the at least one pre-selected portfolio company data may include a Multi-Level Marketing (MLM) company. Further, the at least one training support data may include at least one of a graphic content and a textual content. Further, the training support may assist the at least one user to maximize profits from the at least one pre-selected portfolio company data. Further, the graphic content may include at least one of a picture, a video, an audio, an audio-video, etc.

Further, at 310, the method 300 may include a step of receiving, using the communication device, a first selected company data of the at least one pre-selected portfolio company data from the at least one user device.

Further, at 312, the method 300 may include a step of receiving, using the communication device, a first purchase order data associated with a product of the first selected company data from the at least one user device. Further, the first purchase order data may include an alert that may facilitate purchasing the product of the first selected company data.

Further, at 314, the method 300 may include a step of transmitting, using the communication device, the first purchase order data to a first server associated with the first selected company data. Further, the first server may include a web server, a mail server, etc.

Further, at 316, the method 300 may include a step of receiving, using the communication device, a first transaction profit data associated with the first purchase order data from the first server.

Further, at 318, the method 300 may include a step of analyzing, using the processing device, at least one of the first transaction profit data and the at least one pre-selected portfolio company data to generate a purchase request. Further, the purchase request may be associated with the one of the at least one pre-selected portfolio company data.

Further, at 320, the method 300 may include a step of transmitting, using the communication device, the purchase request to the at least one user device.

Further, at 322, the method 300 may include a step of receiving, using the communication device, a second selected company data of the at least one pre-selected portfolio company data and a second purchase order data from the at least one user device. Further, the purchase request may assist the at least one user to select at least one of a product and the second selected company data.

Further, at 324, the method 300 may include a step of transmitting, using the communication device, the second purchase order data associated with a product of the second selected company data to a second server associated with the second selected company data. Further, the second server may include a web server, a mail server, etc.

Further, at 326, the method 300 may include a step of receiving, using the communication device, a second transaction profit data associated with the second purchase order data from the second server. Further, the first purchase order data may include an alert that may facilitate purchasing the product of the first selected company data.

Further, at 328, the method 300 may include a step of analyzing, using the processing device, the first transaction profit data and the second transaction profit data to generate a subscription alert. Further, the subscription alert may facilitate the at least one user to upgrade a membership on the basis of the first transaction profit data and the second transaction profit data. Further, the membership may include a progressive schedule that may allow the at least one user to pay for the membership upon reaching a predetermined income (or profit) milestone.

Further, at 330, the method 300 may include a step of transmitting, using the communication device, at least one of the first transaction profit data, the second transaction profit data, and the subscription alert to the at least one user device.

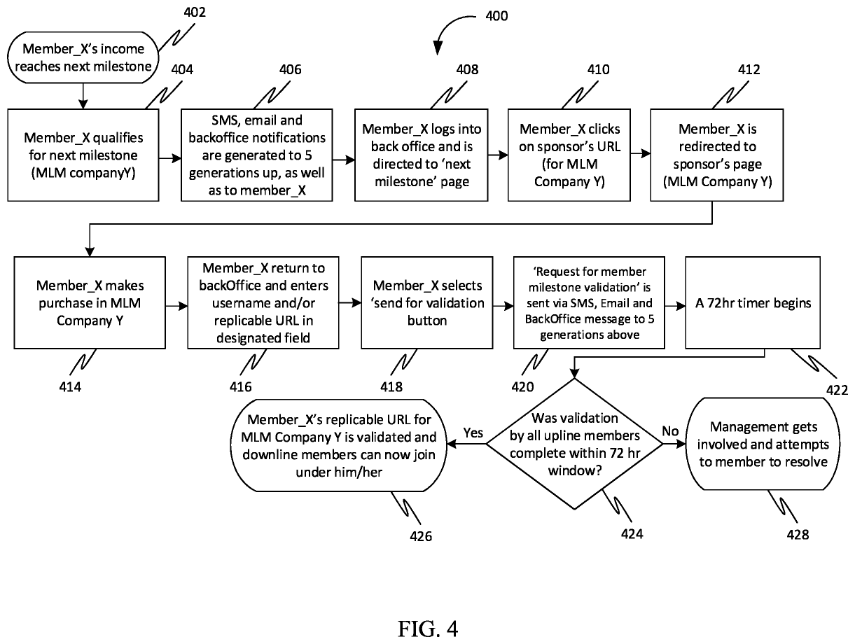

FIG. 4 is a flowchart of a method 400 associated with validation procedure for a new member, in accordance with some embodiments. Accordingly, the new member may be associated with a Multi-Level Marketing (MLM) company. Further, at 402, the method 400 may include an income of the new member reaching a next milestone. Further, at 404, the method 400 may include the new member qualifying for the next milestone. Further, the next milestone may include a second MLM company. Further, at 406, the method 400 may include generating Short Messaging Service (SMS), email, and back-office notifications and transmitted to 5 generations up as well as to the new member. Further, at 408, the method 400 may include the new member logging into a backend office and directing to the “next milestone” page. Further, at 410, the method 400 may include the new member clicking on a sponsor's Universal Resource Locator (URL) associated with a sponsor. Further, the sponsor may be associated with the second MLM company. Further, the sponsor may include an individual, an institution, and an organization. Further, at 412, the method 400 may include redirecting the new member to a sponsor's page associated with the sponsor. Further, the sponsor's page may be associated with the second MLM company. Further, at 414, the method 400 may include the new member to make a purchase in the second MLM company. Further, at 416, the method 400 may include the new member to return to the backend office and entering a username and/or a replicable URL in a designated field. Further, the replicable URL may be associated with the second MLM company. Further, the replicable URL may be associated with the new member. Further, at 418, the method 400 may include selecting a “send for validation” button. Further, at 420, the method 400 may include sending a request for “member milestone validation” via SMS, email, and backend office message to 5 generations above the new member in the second MLM company. Further, at 422, the method 400 may include the beginning of a 72-hours timer. Further, at 424, the method 400 may include checking upline members for validating the request positively. Further, at 426, the method 400 may include validation of the replicable URL of the new member on the basis of response by the upline members. Further, downline members may join under the new member. Further, after the beginning of the 72-hours timer, the method 400 may include checking for the timer to end. Further, upon checking the 72-hours timer to be active, the method 400 may proceed to validation of the replicable URL of the new member. Further, upon ending of the timer, management gets involved (at 428) and attempts to reach out to the 5 generations and the new member are made to resolve.

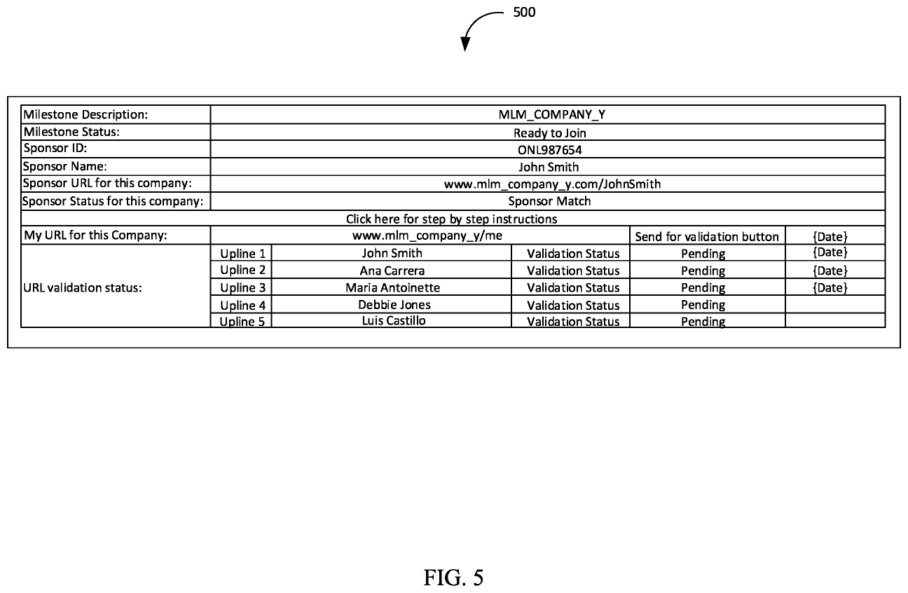

FIG. 5 is a table 500 associated with a new member, in accordance with some embodiments.

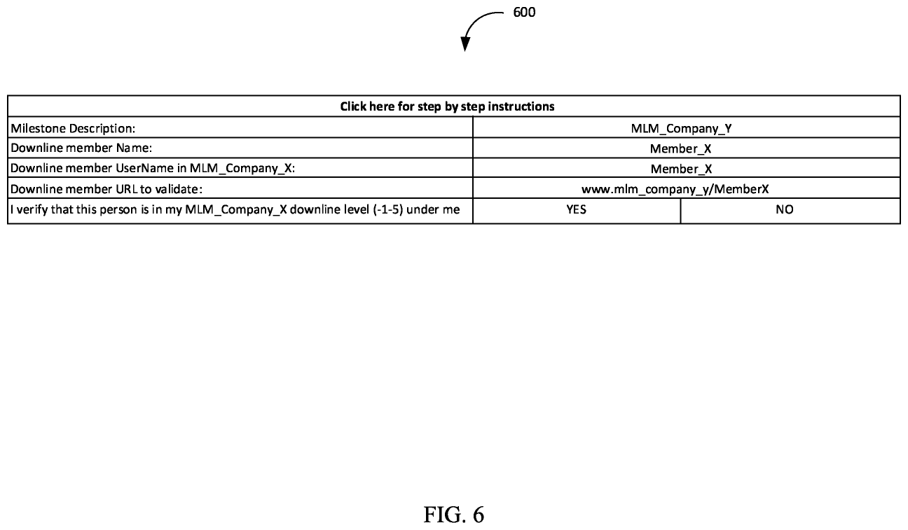

FIG. 6 is a table 600 associated with an upline validation section, in accordance with some embodiments. Further, the upline may include a user's sponsor, the user's sponsor's sponsor, the user's sponsor's sponsor's sponsor, etc.

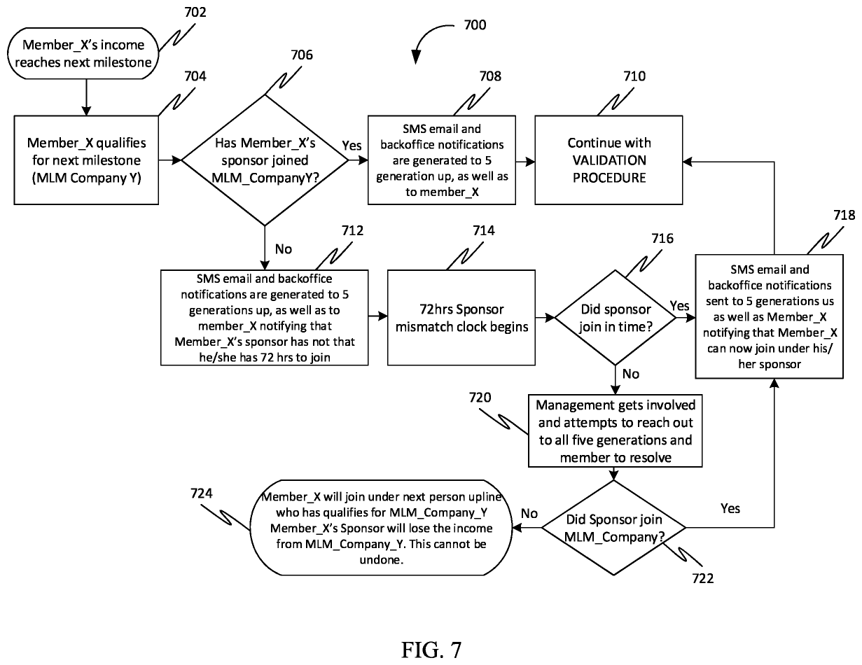

FIG. 7 is a flowchart of a method 700 associated with a sponsor mismatch procedure, in accordance with some embodiments. Accordingly, at 702, the method 700 may include a new member reaching next milestone. Further, the next milestone may include a second Multi-Level Marketing (MLM) company. Further, at 704, the method 700 may include the qualification of the new member for the next milestone. Further, at 706, the method 700 may include checking for the joining of the new member's sponsor in the second MLM company. Further, upon successful validation of the new member's sponsor in the second MLM company, the method 700 may include generating SMS, email, and back-office notifications to 5 generations up as well as the new member (at 708). Further, at 710, the method 700 may include the continuation of a validation procedure. Further, at 712, after checking the new member's sponsor not joining the second MLM company, SMS, email, and back-office notifications are generated to 5 generations up, as well as the new member. Further, at 714, the method 700 may include the beginning of a 72 hours' sponsor mismatch clock. Further, at 716, the method 700 may include checking for the sponsor join MLM company on time. Further, upon the successful joining of the sponsor within time, at 718, the method 700 may include generation of SMS, email, and back-office notifications and sending to the 5 generations up as well as Member_X notifying that the Member_X can now join under his/her sponsor. Further, the method 700 may proceed to the continuation of the validation procedure at 710. Further, upon failing to join the second MLM company by the sponsor, the method 700 may include involvement of the management team and attempts may be made to reach out to the 5 generations and the new member to resolve at 720. Thereafter, at 722, the method 700 may include determining if the sponsor joined MLM_company_Y. If it is determined that the sponsor not joined MLM_company_Y, then at 724, the method 700 may include member_X will join under next person upline who has qualified for MLM_Company_Y. Then Member_X's sponsor will lose the income from MLM_Company_Y. This cannot be undone.

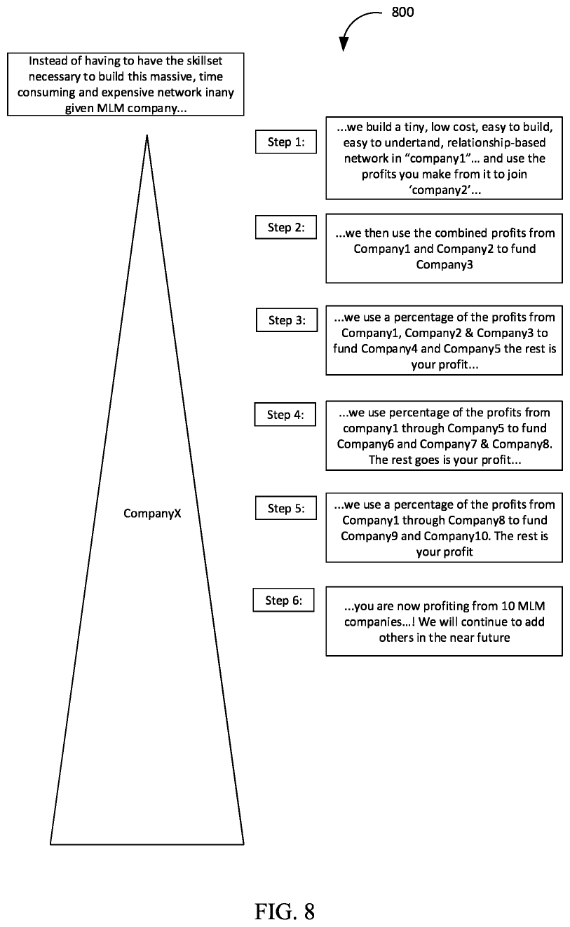

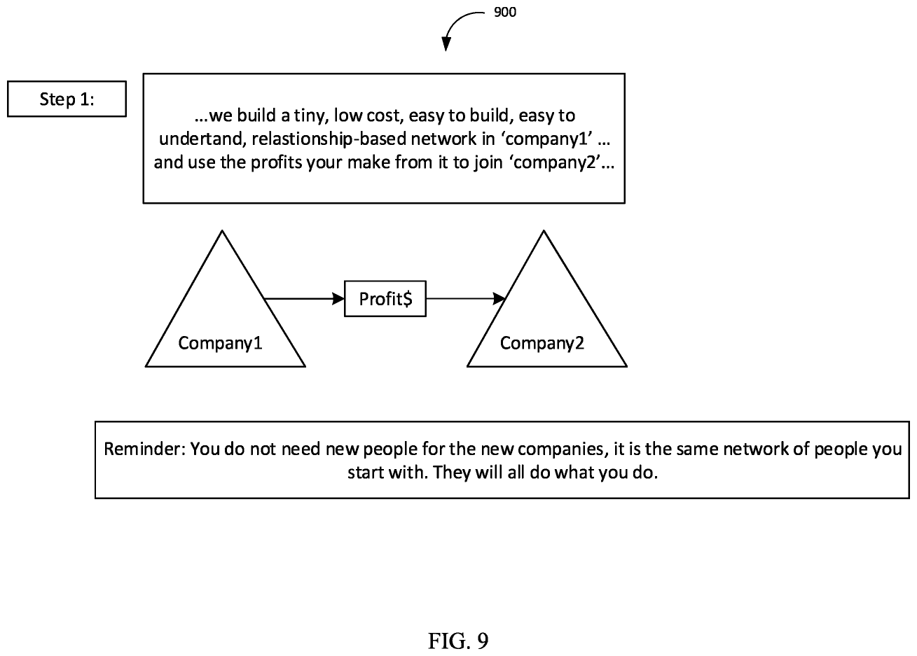

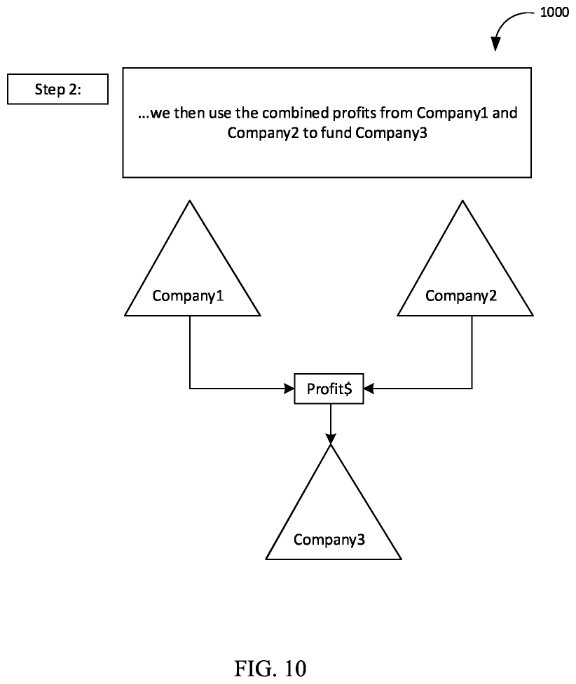

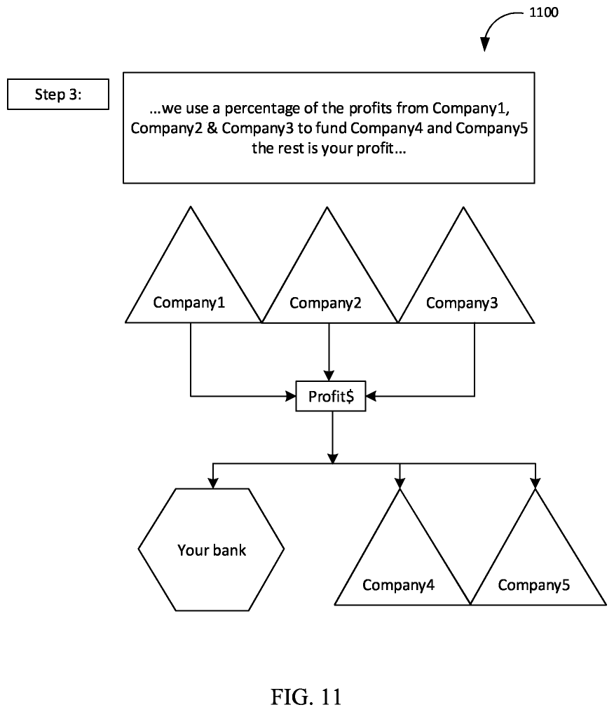

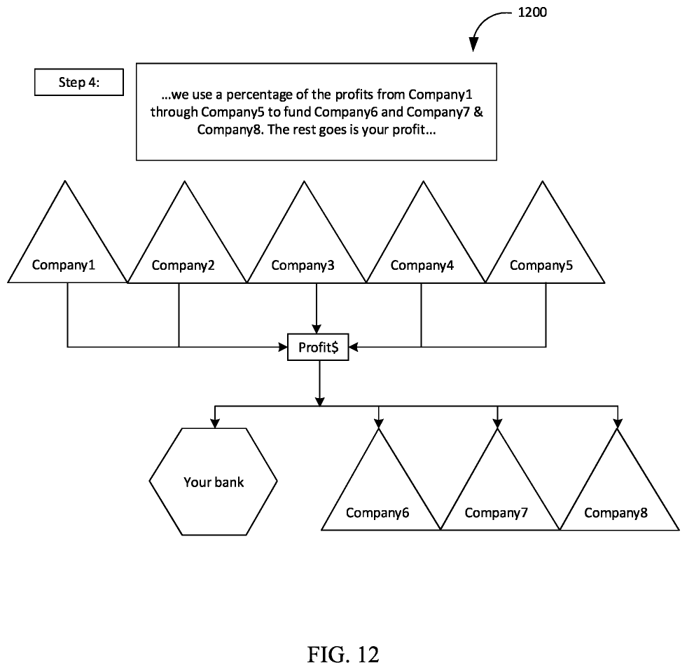

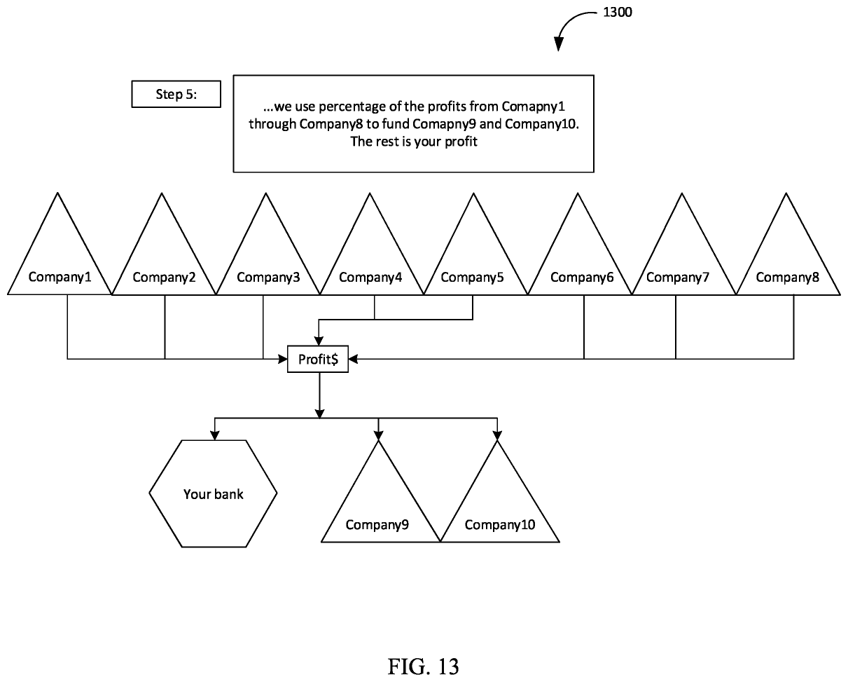

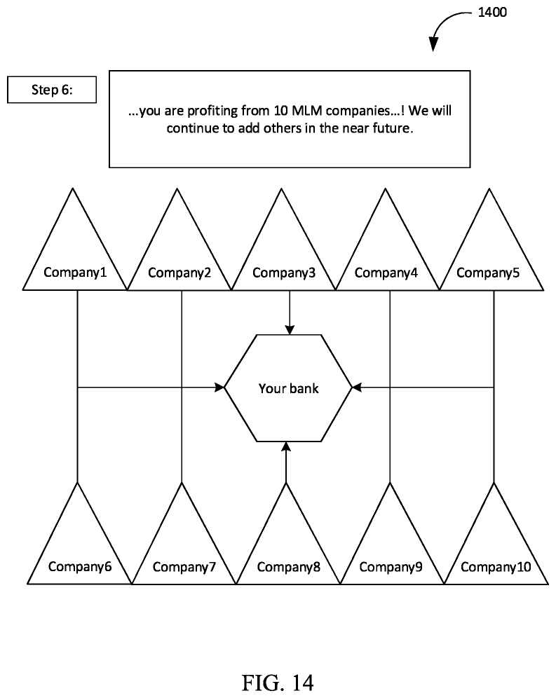

FIG. 8 is a flowchart of a method 800 for reinvestment of profit from a first Multi Level Marketing (MLM) company into one or more MLM companies, in accordance with some embodiments. Further, a user with necessary skills may build a massive, time consuming, and expensive network to invest funds in a single MLM company. Further, the necessary skills may include social media marketing skills, Search Engine Optimization (SEO) campaigns, etc. Further, a step 1 of the method 800 is described in FIG. 9. Further, a step 2 of the method 800 is described in FIG. 10. Further, a step 3 of the method 800 is described in FIG. 11. Further, a step 4 of the method 800 is described in FIG. 12. Further, a step 5 of the method 800 is described in FIG. 13. Further, a step 6 of the method 800 is described in FIG. 14.

FIG. 9 is a flow diagram of a method 900 for reinvestment of profit from the first Multi-Level Marketing (MLM) company into a second Multi-Level Marketing company, in accordance with some embodiments.

FIG. 10 is a flow diagram of a method 1000 for reinvestment of profits from the first Multi-Level Marketing (MLM) company and the second Multi-Level Marketing company into a third MLM company, in accordance with some embodiments.

FIG. 11 is a flow diagram of a method 1100 for reinvestment of profits from the first Multi-Level Marketing (MLM) company, the second Multi-Level Marketing company, the third MLM company into a user bank, a fourth MLM company, and a fifth MLM company, in accordance with some embodiments. Further, the user bank may include a user bank account associated with a user. Further, the user may include an individual, an institution, and an organization.

FIG. 12 is a flow diagram of a method 1200 for reinvestment of profits from the first Multi-Level Marketing (MLM) company, the second Multi-Level Marketing company, the third MLM company, the fourth MLM company, the fifth MLM company into the user bank, a sixth MLM company, a seventh MLM company, and an eight MLM company, in accordance with some embodiments.

FIG. 13 is a flow diagram of a method 1300 for reinvestment of profits from the first Multi-Level Marketing (MLM) company, the second Multi-Level Marketing company, the third MLM company, the fourth MLM company, the fifth MLM company, the sixth MLM company, the seventh MLM company, the eight MLM company into the user bank, a ninth MLM company, and a tenth MLM company, in accordance with some embodiments.

FIG. 14 is a flow diagram of a method 1400 for reinvestment of profits from the first Multi-Level Marketing (MLM) company, the second Multi-Level Marketing company, the third MLM company, the fourth MLM company, the fifth MLM company, the sixth MLM company, the seventh MLM company, the eight MLM company, the ninth MLM company, and the tenth MLM company into the user bank, in accordance with some embodiments.

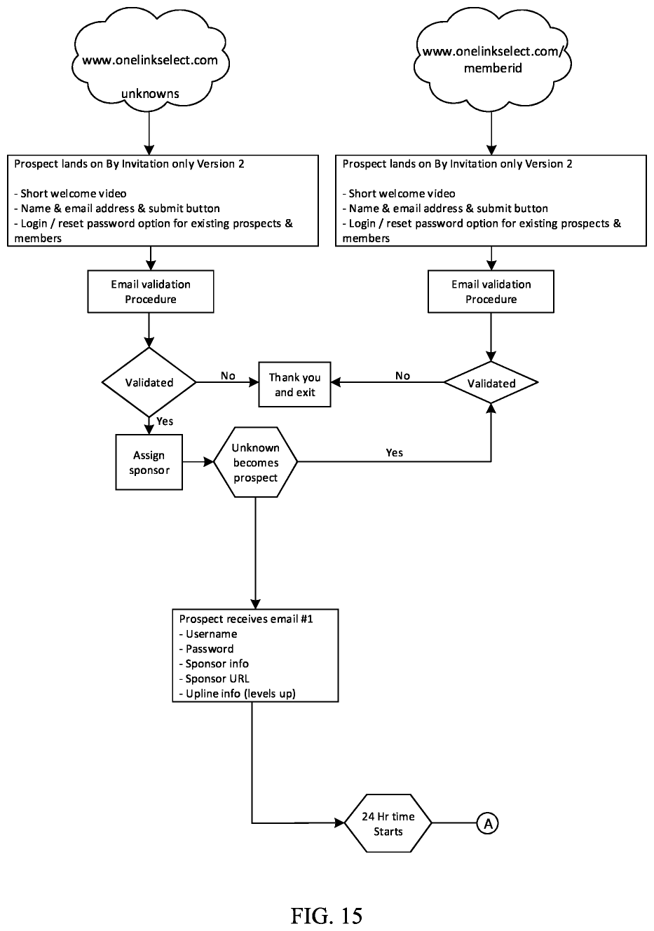

FIG. 15 is a flowchart of a schema associated with a method for facilitating capitalizing on a portfolio of pre-selected Multi-Level Marketing companies, in accordance with some embodiments.

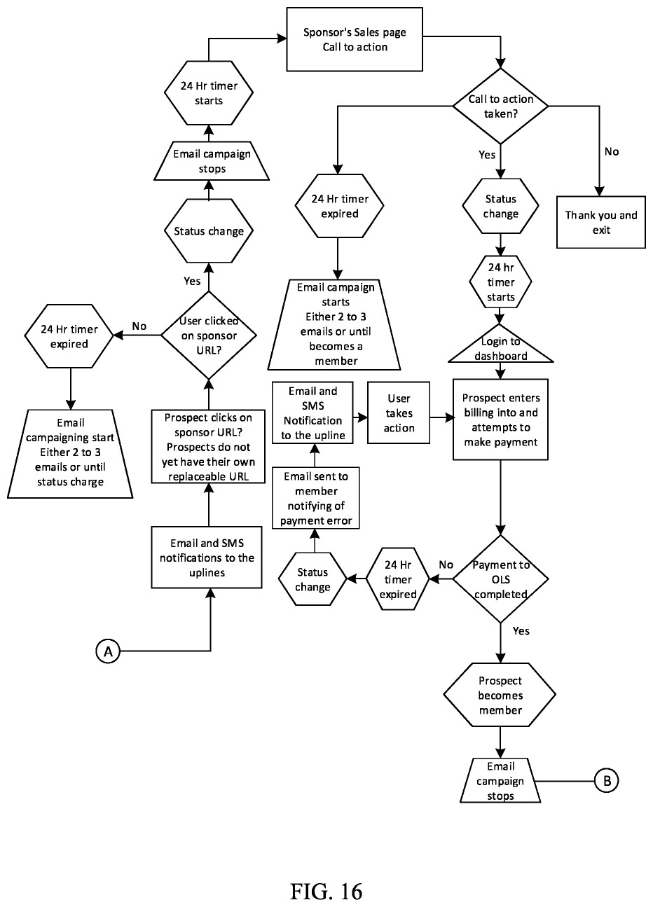

FIG. 16 is a continuation flowchart of FIG. 15.

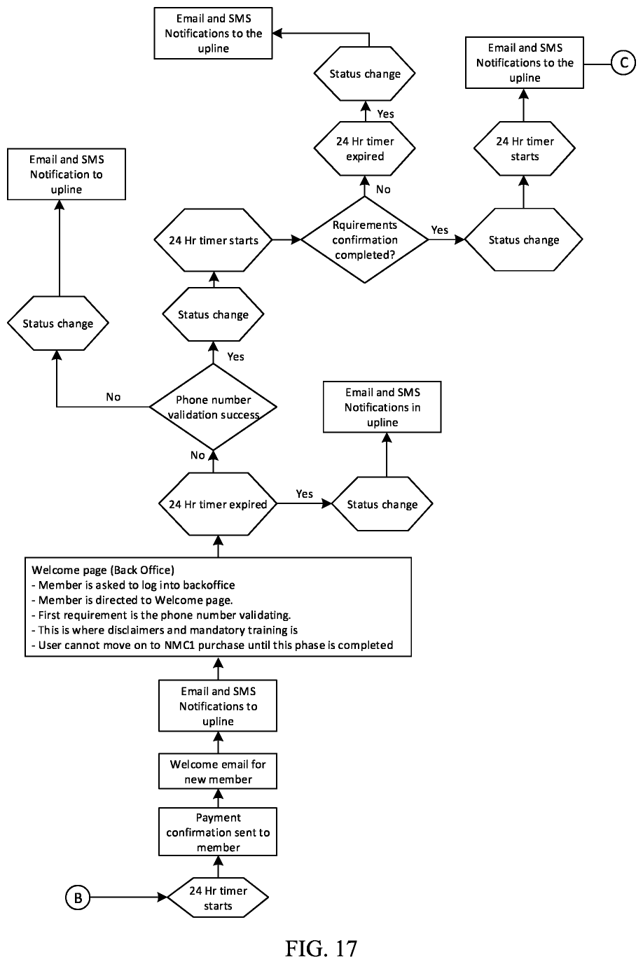

FIG. 17 is a continuation flowchart of FIGS. 15 and 16.

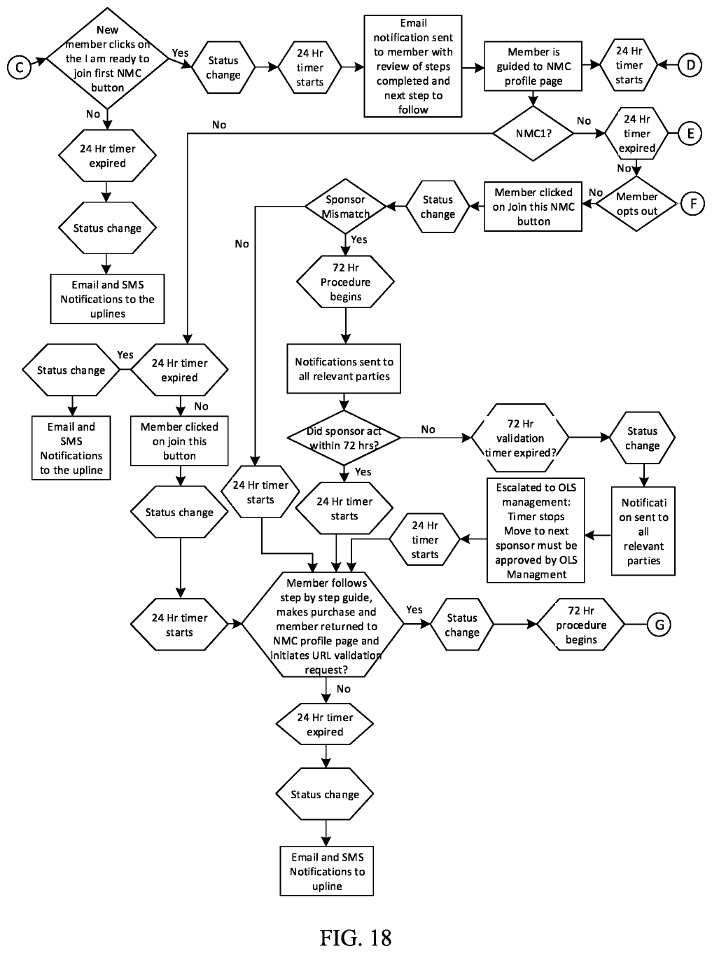

FIG. 18 is a continuation flowchart of FIGS. 15, 16 and 17.

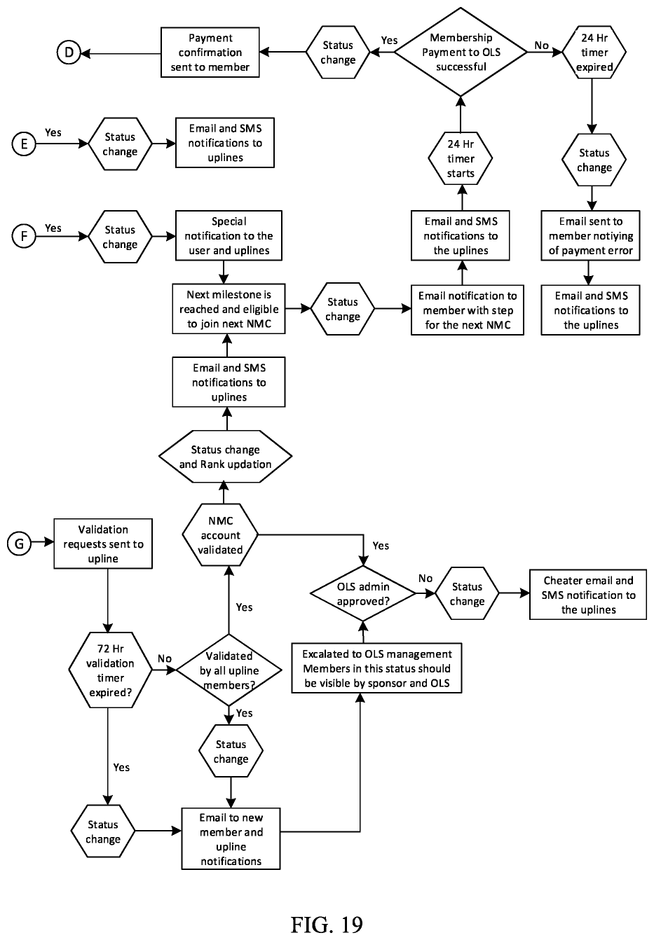

FIG. 19 is a continuation flowchart of FIGS. 15, 16, 17 and 18.

In some embodiments, a ledger may include one or more of the following:
Network Marketing and Multi-Level Marketing (MLM) are interchangeable terms
When referring to the industry in general, I will use the term MLM Companies
I will refer to the MLM companies in our portfolio/system/platform as NMC's (NMC1, NMC2, NMC3 etc.),
OLS refers to our system/platform

According to some embodiments, a Portfolio Approach Custom Function (Innovation 1) may include following features:
Instead of having to create a massive network in a single MLM company, which takes immense effort, resources and time, our members will use our system to generate a small network and use it to generate income from multiple MLM companies.
Our platform will guide users on a step-by-step, milestone-based, custom process so that they can use the same network across multiple MLM companies.

According to some embodiments, a Reinvestment from Profits Custom Function (Innovation 2) may include following features:
In order to keep upfront and monthly costs to a minimum, the system is designed to use the income/commissions generated from the first MLM company in the portfolio to finance all following MLM companies as well as our memberships,
What this means is that the member's out of pocket monthly expenses ends once they are making at least the amount they are paying monthly (for NMC1 and Membership) and from there on, all future expenses come from profits,
The income/commissions produced by members from all subsequent MLM companies (NMC2, NMC3, NMC4 etc.) will be theirs to keep.

According to some embodiments, a Reciprocal/Progressive Membership Custom Function (Innovation 3) may include following features:
This function is directly tied to the reinvestment from profits
We believe that our system is quite valuable, but instead of charging our due upfront, we will progressively increase our membership as the member reaches their next milestone.
Since this milestone (a dollar amount) is already predetermined and covered by the Reinvestment from Profit Function, there is no additional out of pocket expense for the member.

According to some embodiments, a Member Validation Function (Innovation 4) may include following features:
In order to ensure that the referential integrity of the network's structure is maintained across multiple MLM companies, in other words so that members always fall under their correct sponsor and more importantly, under their correct downline, the following custom validation/verification process was created.
   When a member qualifies for any of the NMC's—including the initial NMC and signs up as a distributor/affiliate of said NMC, the member will have to return to our platform's back office and enter his replicable URL.
   The member's status will be ‘pending’
   Communications are then sent to the members upline (via email, SMS Messaging, Notification in their back office and the app)
   Upline members will then go to the relevant NMC back office, verify that the member who is requesting validation has submitted correct information and either approve or deny the validation.
   Only when the predetermined number of upline members perform their validation will the requesting member's status change to ‘validated’
   All non-validated cases will be handled on a case-by-case scenario,
   Futuring
   In the future—depending on cooperation from the NMC's in our portfolio—we will improve this function by using API calls.

According to some embodiments, a Sponsor Mismatch Function (Innovation 5) may include following features:
If a member qualifies for a given NMC company (including NMC1) but his or her sponsor in OLS has not become an affiliate of it, the member's sponsor will have a predetermined amount of time to make the decision of either joining the relevant NMC or not.
Communications will be generated (via email, SMS, OLC's back office, the app, phone calls) at timely intervals to assist the sponsor to make a decision,
If the sponsor in question fails to join the relevant NMC within the allotted time or chooses to not join said NMC then that member will skip their OLS sponsor for the relevant NMC and become a direct downline of the next qualifying sponsor.

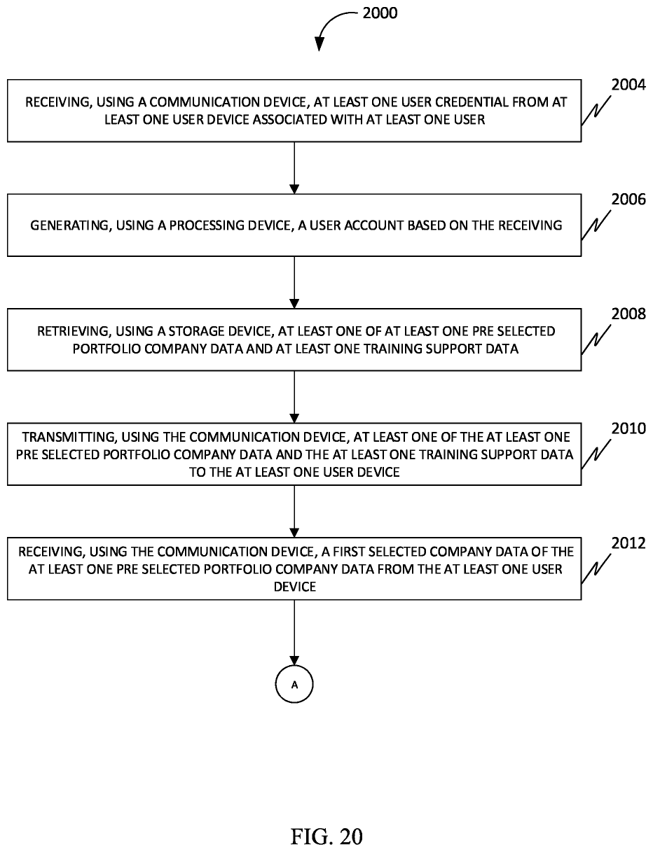

FIG. 20 is a flow chart of a method 2000 for facilitating capitalizing on a portfolio of pre-selected Multi-Level Marketing companies, in accordance with some embodiments.

Further, at 2004, the method 2000 may include receiving, using a communication device, at least one user credential from at least one user device associated with at least one user.

Further, at 2006, the method 2000 may include generating, using a processing device, a user account based on the receiving.

Further, at 2008, the method 2000 may include retrieving, using a storage device, at least one of at least one pre-selected portfolio company data and at least one training support data.

Further, at 2010, the method 2000 may include transmitting, using the communication device, at least one of the at least one pre-selected portfolio company data and the at least one training support data to the at least one user device.

Further, at 2012, the method 2000 may include receiving, using the communication device, a first selected company data of the at least one pre-selected portfolio company data from the at least one user device.

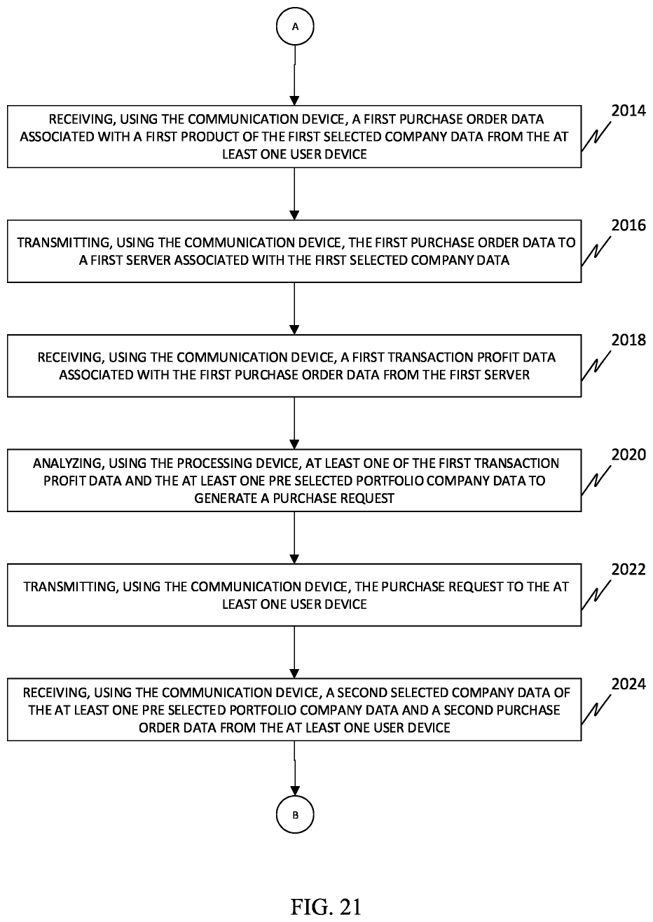

FIG. 21 is a continuation flow chart of FIG. 20. Further, at 2014, the method 2000 may include receiving, using the communication device, a first purchase order data associated with a first product of the first selected company data from the one or more user devices.

Further, at 2016, the method 2000 may include transmitting, using the communication device, the first purchase order data to a first server associated with the first selected company data.

Further, at 2018, the method 2000 may include receiving, using the communication device, a first transaction profit data associated with the first purchase order data from the first server.

Further, at 2020, the method 2000 may include analyzing, using the processing device, one or more of the first transaction profit data and the one or more pre selected portfolio company data to generate a purchase request.

Further, at 2022, the method 2000 may include transmitting, using the communication device, the purchase request to the one or more user devices.

Further, at 2024, the method 2000 may include receiving, using the communication device, a second selected company data of the one or more pre-selected portfolio company data and a second purchase order data from the one or more user devices.

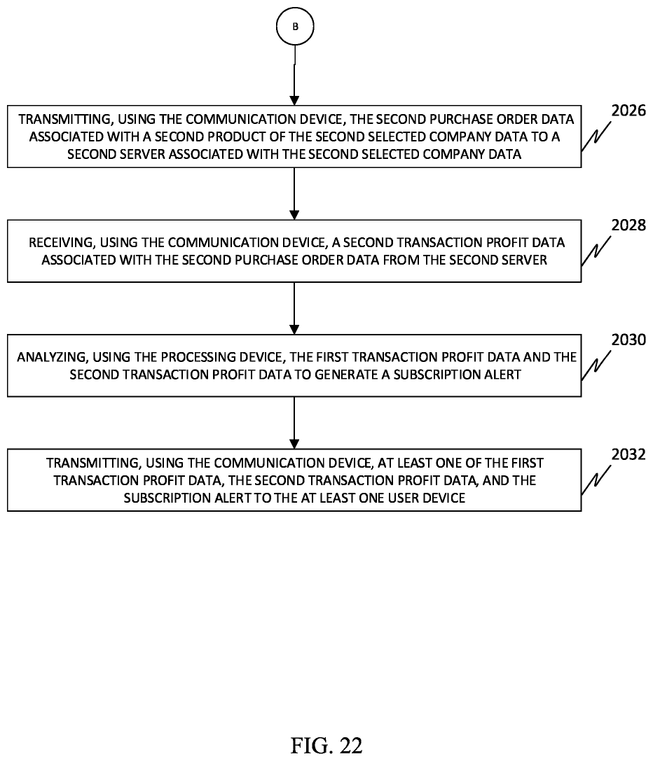

FIG. 22 is a continuation flow chart of FIG. 21. Further, at 2026, the method 2000 may include transmitting, using the communication device, the second purchase order data associated with a second product of the second selected company data to a second server associated with the second selected company data.

Further, at 2028, the method 2000 may include receiving, using the communication device, a second transaction profit data associated with the second purchase order data from the second server.

Further, at 2030, the method 2000 may include analyzing, using the processing device, the first transaction profit data and the second transaction profit data to generate a subscription alert.

Further, at 2032, the method 2000 may include transmitting, using the communication device, one or more of the first transaction profit data, the second transaction profit data, and the subscription alert to the one or more user devices.

In some embodiments, the subscription alert may inform the at least one user to upgrade a membership on the basis of the first transaction profit data and the second transaction profit data.

In some embodiments, the membership may include a progressive schedule that allows the at least one user to pay for the membership upon reaching a predetermined milestone corresponding to at least one of a profit and an income.

In some embodiments, the second purchase order may be fulfilled based on a reinvestment of at least a portion of fund corresponding to the first transaction profit data into the second product corresponding to the second selected company data.

In some embodiments, the first purchase order data may include an alert configured to facilitate purchasing of the first product corresponding to the first selected company data.

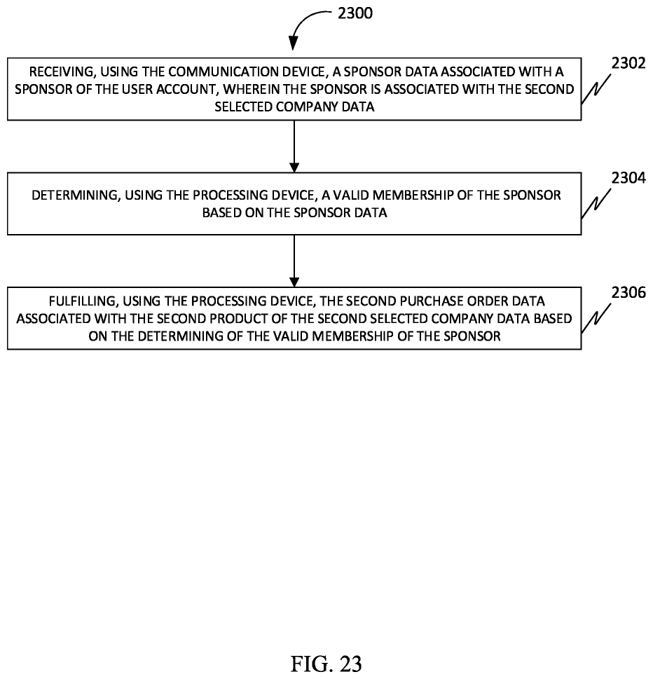

FIG. 23 is a flow chart of a method 2300 for facilitating capitalizing on a portfolio of pre-selected Multi-Level Marketing companies, in accordance with further embodiments.

Further, at 2302, the method 2300 may include receiving, using the communication device, a sponsor data associated with a sponsor of the user account. Further, the sponsor may be associated with the second selected company data.

Further, at 2304, the method 2300 may include determining, using the processing device, a valid membership of the sponsor based on the sponsor data.

In some embodiments, the determining of the valid membership may be performed after a predetermined time-frame subsequent to the receiving of the second purchase order data.

Further, at 2306, the method 2300 may include fulfilling, using the processing device, the second purchase order data associated with the second product of the second selected company data based on the determining of the valid membership of the sponsor.

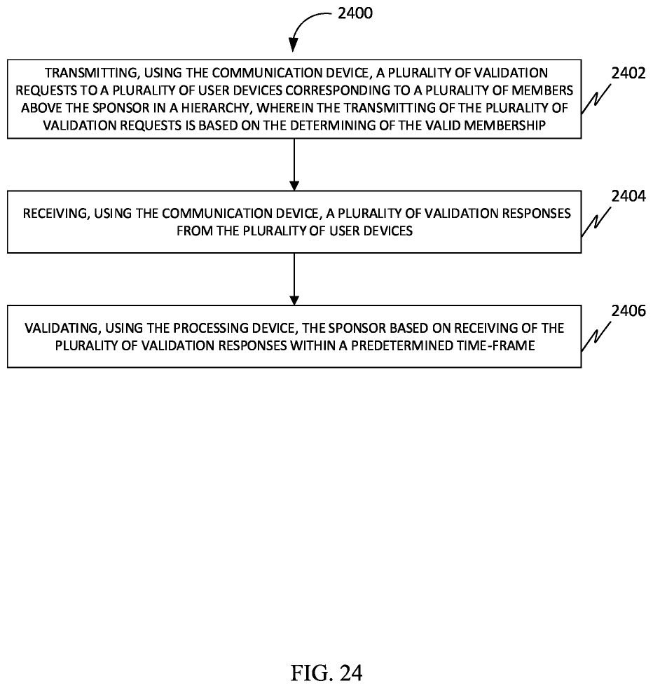

FIG. 24 is a flow chart of a method 2400 for facilitating capitalizing on a portfolio of pre-selected Multi-Level Marketing companies, in accordance with further embodiments.

Further, at 2402, the method 2400 may include transmitting, using the communication device, a plurality of validation requests to a plurality of user devices corresponding to a plurality of members above the sponsor in a hierarchy. Further, the transmitting of the plurality of validation requests may be based on the determining of the valid membership.

Further, at 2404, the method 2400 may include receiving, using the communication device, a plurality of validation responses from the plurality of user devices.

Further, at 2406, the method 2400 may include validating, using the processing device, the sponsor based on receiving.

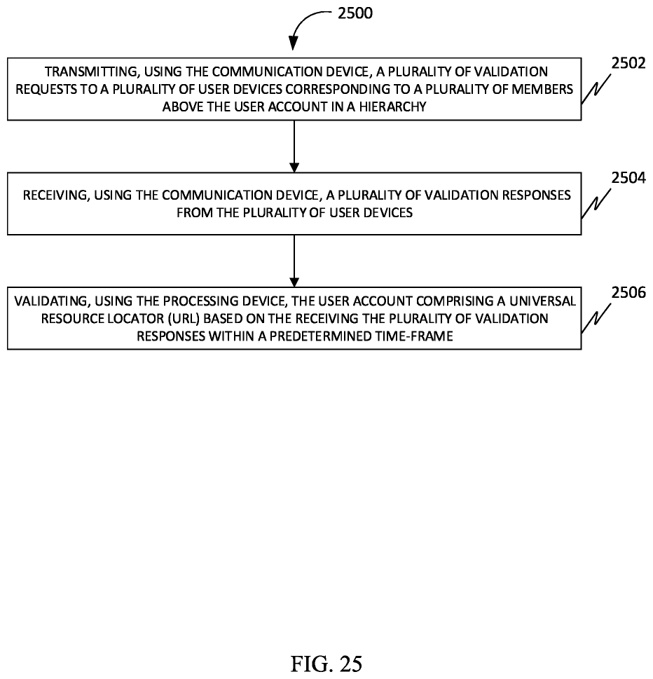

FIG. 25 is a flow chart of a method 2500 for facilitating capitalizing on a portfolio of pre-selected Multi-Level Marketing companies, in accordance with further embodiments.

Further, at 2502, the method 2500 may include transmitting, using the communication device, a plurality of validation requests to a plurality of user devices corresponding to a plurality of members above the user account in a hierarchy.

Further, at 2504, the method 2500 may include receiving, using the communication device, a plurality of validation responses from the plurality of user devices.

According to some embodiments, the plurality of validation requests may correspond to a milestone validation corresponding to the user account.

Further, at 2506, the method 2500 may include validating, using the processing device, the user account comprising a Universal Resource Locator (URL) based on the receiving the plurality of validation responses within a predetermined timeframe.

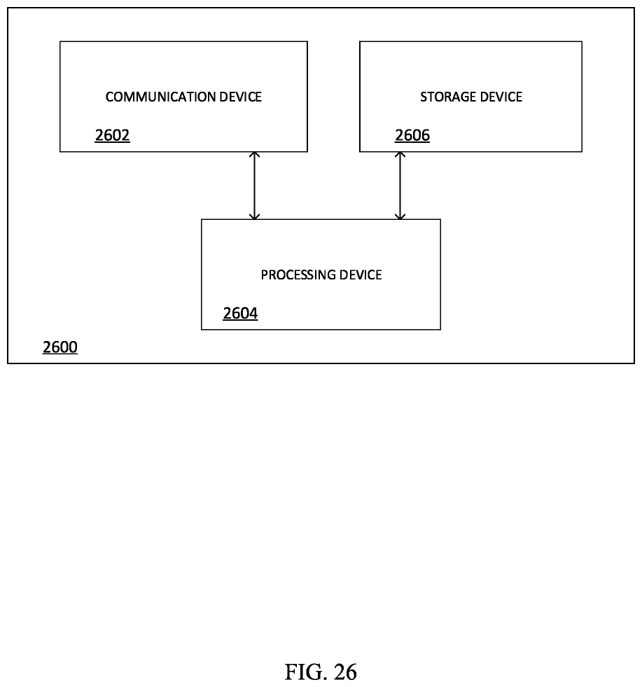

FIG. 26 is a block diagram of a system 2600 for facilitating capitalizing on a portfolio of pre-selected Multi-Level Marketing companies, in accordance with some embodiments. The system 2600 may include a communication device 2602, a processing device 2604 and a storage device 2606.

Further, the communication device 2602 may be configured for performing a step of receiving one or more user credential from one or more user devices associated with one or more user.

Further, the communication device 2602 may be configured for performing a step of transmitting one or more of one or more pre-selected portfolio company data and one or more training support data to the one or more user devices.

Further, the communication device 2602 may be configured for performing a step of receiving a first selected company data of the one or more pre-selected portfolio company data from the one or more user devices.

Further, the communication device 2602 may be configured for performing a step of receiving a first purchase order data associated with a first product of the first selected company data from the one or more user devices.

Further, the communication device 2602 may be configured for performing a step of transmitting the first purchase order data to a first server associated with the first selected company data.

Further, the communication device 2602 may be configured for performing a step of receiving a first transaction profit data associated with the first purchase order data from the first server.

Further, the communication device 2602 may be configured for performing a step of transmitting a purchase request to the one or more user devices.

Further, the communication device 2602 may be configured for performing a step of receiving a second selected company data of the one or more pre-selected portfolio company data and a second purchase order data from the one or more user devices.

Further, the communication device 2602 may be configured for performing a step of transmitting the second purchase order data associated with a product of the second selected company data to a second server associated with the second selected company data.

Further, the communication device 2602 may be configured for performing a step of receiving a second transaction profit data associated with the second purchase order data from the second server.

Further, the communication device 2602 may be configured for performing a step of transmitting, using the communication device, one or more of the first transaction profit data, the second transaction profit data, and a subscription alert to the one or more user devices.

Further, the processing device 2604 may be configured for performing a step of generating a user account based on the receiving of the user credentials.

Further, the processing device 2604 may be configured for performing a step of analyzing one or more of the first transaction profit data and the one or more pre-selected portfolio company data to generate the purchase request.

Further, the processing device 2604 may be configured for performing a step of analyzing the first transaction profit data and the second transaction profit data to generate the subscription alert.

Further, the storage device 2606 may be configured for performing a step of retrieving one or more of the one or more pre-selected portfolio company data and the one or more training support data.

In some embodiments, the subscription alert informs the one or more user to upgrade a membership on the basis of the first transaction profit data and the second transaction profit data.

In further embodiments, the membership may include a progressive schedule that allows the one or more user to pay for the membership upon reaching a predetermined milestone corresponding to one or more of a profit and an income.
In some embodiments, a second purchase order associated with the second purchase order data may be fulfilled based on a reinvestment of at least a portion of fund corresponding to the first transaction profit data into the second product corresponding to the second selected company data.

In some embodiments, the communication device 2602 may be configured for performing a step of receiving a sponsor data associated with a sponsor of the user account. Further, the sponsor may be associated with the second selected company data. Further, the processing device 2604 may be configured for performing a step of determining a valid membership of the sponsor based on the sponsor data. Further, the processing device 2604 may be configured for performing a step of fulfilling the second purchase order data associated with the second product of the second selected company data based on the determining of the valid membership of the sponsor.

In some embodiments, the determining of the valid membership may be performed after a predetermined time-frame subsequent to the receiving of the second purchase order data.

In further embodiments, the communication device 2602 may be configured for transmitting a plurality of validation requests to a plurality of user devices corresponding to a plurality of members above the sponsor in a hierarchy. Further, the transmitting of the plurality of validation requests may be based on the determining of the valid membership. Further, the communication device 2602 may be configured for receiving a plurality of validation responses from the plurality of user devices. Further, the processing device 2604 may be configured for validating the sponsor based on receiving of the plurality of validation responses within a predetermined timeframe.

Further, the first purchase order data may include an alert configured to facilitate purchasing of the first product corresponding to the first selected company data.

In further embodiments, the communication device 2602 may be configured for transmitting a plurality of validation requests to a plurality of user devices corresponding to a plurality of members above the user account in a hierarchy. Further, the communication device 2602 may be configured for receiving a plurality of validation responses from the plurality of user devices. Further, the processing device 2604 may be configured for validating the user account comprising a Universal Resource Locator (URL) based on the receiving the plurality of validation responses within a predetermined timeframe.

In further embodiments, the plurality of validation requests may correspond to a milestone validation corresponding to the user account.

According to some other embodiments, the present disclosure also provides a method of facilitating capitalizing on a portfolio of pre-selected Multi-Level Marketing companies.

Accordingly, the method may include receiving, using a communication device, a first MLM company data associated with a first MLM company from a first member device associated with a first member. In an instance, the first MLM company may be associated with a first product. Accordingly, the first member may be required to purchase the first product in order to join the first MLM company. Accordingly, in some embodiments, the method may include receiving, using the communication device, a first purchase order from the first member device in order to join the first MLM company.

Further, in an instance, the first MLM company data may include information corresponding to the first MLM company such as, but not limited to, a name of the first MLM company. Additionally, in some embodiments, the first MLM company data may additionally include a first product identifier associated with a first product sold by the first MLM company. Further, in some embodiments, the first MLM company data may also include, a first hierarchy data corresponding to the first MLM company. The first hierarchy data may represent a membership hierarchy of the first MLM company associated with the first member. For example, the first hierarchy data may include a first ordered list of member identifiers corresponding to a plurality of first members who are part of the first MLM company. Additionally, the first hierarchy data may indicate a hierarchical relationship between the first member and one or more of the plurality of first members. For instance, the hierarchy data may indicate that the first member is under a first higher-level member who in turn is under a second higher level member who is in turn under a third higher level member and so on. Similarly, in some instances, the hierarchy data may indicate that the first member has a first lower-level member under the first member, a second lower level member under the first lower member, a third lower level member under the second lower level member and so on.

Further, the method may include receiving, using the communication device, a first transaction profit data from the first member device. In instance, the first transaction profit data may indicate a monetary profit attributed to the first member as a result of profits generated by the first MLM company. For example, the monetary profit may include commissions earned by the first member as a result of products sold by the first lower-level members under the first member and/or by the first higher level members.

Further, the method may include analyzing, using a processing device, the first MLM company data and the first transaction profit data of the first member. For instance, the method may use one or more techniques such as machine learning, artificial intelligence, big data analytics for performing the analyzing. Additionally, in some embodiments, the method may include retrieving, using a storage device, additional relevant data and subsequently analyzing the additional relevant data. Such additional relevant data may include, for example, market data corresponding to the first MLM company data, the first product, social media profiles corresponding to the plurality of first members (including the first member), online and/or offline behavior data corresponding to the plurality of first members (including the first member) and audit data corresponding to the first MLM company. In an instance, the offline behavior data may include location data captured using a location sensor comprised in the plurality of member devices. In another instance, the offline behavior data may include audio and/or video data captured, during a sales process, using a microphone and/or a camera respectively comprised in the plurality of member devices. Additionally, in some embodiments, the offline behavior data may include gesture data captured using a motion sensor. In an instance, the gesture data may indicate one or more gestures performed by the first member during a sales process.

Further, the method may include determining an upgrade eligibility based on the analyzing of the first MLM company data and the first transaction profit data. The upgrade eligibility may indicate eligibility of the first member to become part of a second MLM company. Accordingly, in an instance, if the first transaction profit data reaches a predetermined milestone value, the first member may be determined to be eligible for an upgrade. In some other embodiments, the upgrade eligibility may also be determined based on the analyzing of the additional relevant data. For example, the upgrade eligibility may be determined based on a level of participation of the first member inferred from analyzing the additional relevant data. Factors such as a number of locations visited, a number of other potential members interacted with, an effectiveness of selling etc. may be considered in determining the level of participation. In an instance, the effectiveness of selling may be determined based on analyzing of the audio and/or video data captured during a sales process. Further, in some embodiments, the effectiveness of selling may also be determined based on analyzing of body language and/or gestures performed by the first member as determined from the gesture data.

Further, the method may include identifying, using the processing device, a second MLM company based on determining the upgrade eligibility. Further, the method may include transmitting, using the communication device, a subscription alert to the first member device. In an instance, the subscription alert may include indication of the second MLM company so that the first member may, if interested, join the second MLM company. In an instance, the second MLM company may be associated with a second product. Additionally, the first member may be required to purchase the second product in order to join the second MLM company. Accordingly, the method may include receiving, using the communication device, a second purchase order from the first member device in order to join the second MLM company.

In some embodiments, the method may include receiving, using the communication device, an approval from the first member device indicating express interest from the first member to join the second MLM company.

Further, the method may include automatically generating and issuing the second purchase order on behalf of the first member. Further, the second purchase order may be fulfilled using monetary funds derived from the first transaction profit earned from the first MLM company. For example, in an instance, a predetermined portion of the first transaction profit may be used for investing in the second MLM company. In another example, all of the first transaction profit may be used for investing in the second MLM company. As a result, the first member may join two or more MLM companies in a progressive manner according to one or more upgrade eligibility which may in turn be based on multiple criteria by reinvesting profits earned from one or more first MLM companies into one or more second MLM companies. Consequently, over a period of time, the first member may form and capitalize a portfolio of multiple MLM companies.

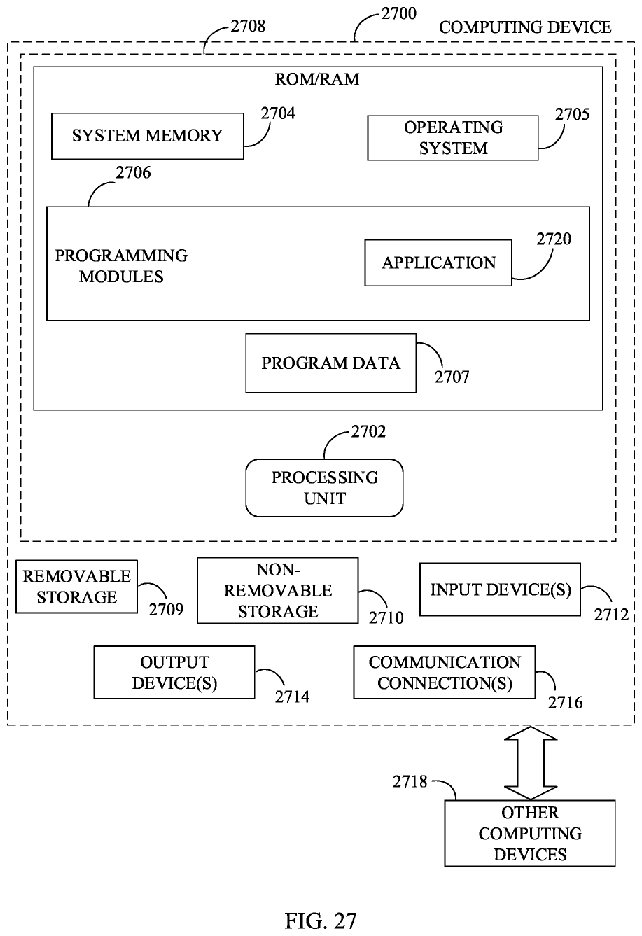

With reference to FIG. 27, a system consistent with an embodiment of the disclosure may include a computing device or cloud service, such as computing device 2700. In a basic configuration, computing device 2700 may include at least one processing unit 2702 and a system memory 2704. Depending on the configuration and type of computing device, system memory 2704 may comprise, but is not limited to, volatile (e.g., random-access memory (RAM)), non-volatile (e.g., read-only memory (ROM)), flash memory, or any combination. System memory 2704 may include operating system 2705, one or more programming modules 2706, and may include a program data 2707. Operating system 2705, for example, may be suitable for controlling computing device 2700′s operation. In one embodiment, programming modules 2706 may include image-processing module, machine learning module. Furthermore, embodiments of the disclosure may be practiced in conjunction with a graphics library, other operating systems, or any other application program and is not limited to any particular application or system. This basic configuration is illustrated in FIG. 27 by those components within a dashed line 2708.

Computing device 2700 may have additional features or functionality. For example, computing device 2700 may also include additional data storage devices (removable and/or non-removable) such as, for example, magnetic disks, optical disks, or tape. Such additional storage is illustrated in FIG. 27 by a removable storage 2709 and a non-removable storage 2710. Computer storage media may include volatile and non-volatile, removable, and non-removable media implemented in any method or technology for storage of information, such as computer-readable instructions, data structures, program modules, or other data. System memory 2704, removable storage 2709, and non-removable storage 2710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by computing device 2700. Any such computer storage media may be part of device 2700. Computing device 2700 may also have input device(s) 2712 such as a keyboard, a mouse, a pen, a sound input device, a touch input device, a location sensor, a camera, a biometric sensor, etc. Output device(s) 2714 such as a display, speakers, a printer, etc. may also be included. The aforementioned devices are examples and others may be used.

Computing device 2700 may also contain a communication connection 2716 that may allow device 2700 to communicate with other computing devices 2718, such as over a network in a distributed computing environment, for example, an intranet or the Internet. Communication connection 2716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2704, including operating system 2705. While executing on processing unit 2702, programming modules 2706 (e.g., application 2720 such as a media player) may perform processes including, for example, one or more stages of methods, algorithms, systems, applications, servers, databases as described above. The aforementioned process is an example, and processing unit 2702 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method for facilitating capitalizing on a portfolio of pre-selected Multi-Level Marketing companies comprising:
receiving, using a communication device, at least one user credential from at least one user device associated with at least one user;
generating, using a processing device, a user account based on the receiving;
retrieving, using a storage device, at least one of at least one pre-selected portfolio company data and at least one training support data;
transmitting, using the communication device, at least one of the at least one pre-selected portfolio company data and the at least one training support data to the at least one user device;
receiving, using the communication device, a first selected company data of the at least one pre-selected portfolio company data from the at least one user device;
receiving, using the communication device, a first purchase order data associated with a first product of the first selected company data from the at least one user device;
transmitting, using the communication device, the first purchase order data to a first server associated with the first selected company data;
receiving, using the communication device, a first transaction profit data associated with the first purchase order data from the first server;
analyzing, using the processing device, at least one of the first transaction profit data and the at least one pre-selected portfolio company data to generate a purchase request;
transmitting, using the communication device, the purchase request to the at least one user device;
receiving, using the communication device, a second selected company data of the at least one preselected portfolio company data and a second purchase order data from the at least one user device;
transmitting, using the communication device, the second purchase order data associated with a second product of the second selected company data to a second server associated with the second selected company data;
receiving, using the communication device, a second transaction profit data associated with the second purchase order data from the second server;
analyzing, using the processing device, the first transaction profit data and the second transaction profit data to generate a subscription alert; and
transmitting, using the communication device, at least one of the first transaction profit data, the second transaction profit data, and the subscription alert to the at least one user device.

2. The method of claim 1, wherein the subscription alert informs the at least one user to upgrade a membership on the basis of the first transaction profit data and the second transaction profit data.

3. The method of claim 2, wherein the membership comprises a progressive schedule that allows the at least one user to pay for the membership upon reaching a predetermined milestone corresponding to at least one of a profit and an income.

4. The method of claim 1, wherein a second purchase order associated with the second purchase order data is fulfilled based on a reinvestment of at least a portion of fund corresponding to the first transaction profit data into the second product corresponding to the second selected company data.

5. The method of claim 3 further comprising:
receiving, using the communication device, a sponsor data associated with a sponsor of the user account, wherein the sponsor is associated with the second selected company data;
determining, using the processing device, a valid membership of the sponsor based on the sponsor data; and
fulfilling, using the processing device, the second purchase order data associated with the second product of the second selected company data based on the determining of the valid membership of the sponsor.

6. The method of claim 5, wherein the determining of the valid membership is performed after a predetermined time-frame subsequent to the receiving of the second purchase order data.

7. The method of claim 5 further comprising:
transmitting, using the communication device, a plurality of validation requests to a plurality of user devices corresponding to a plurality of members above the sponsor in a hierarchy, wherein the transmitting of the plurality of validation requests is based on the determining of the valid membership;
receiving, using the communication device, a plurality of validation responses from the plurality of user devices; and
validating, using the processing device, the sponsor based on receiving of the plurality of validation responses within a predetermined timeframe.

8. The method of claim 1, wherein the first purchase order data comprises an alert configured to facilitate purchasing of the first product corresponding to the first selected company data.

9. The method of claim 1 further comprising:
transmitting, using the communication device, a plurality of validation requests to a plurality of user devices corresponding to a plurality of members above the user account in a hierarchy;
receiving, using the communication device, a plurality of validation responses from the plurality of user devices; and
validating, using the processing device, the user account comprising a Universal Resource Locator (URL) based on the receiving the plurality of validation responses within a predetermined timeframe.

10. The method of claim 9, wherein the plurality of validation requests corresponds to a milestone validation corresponding to the user account.

11. A system for facilitating capitalizing on a portfolio of pre-selected Multi-Level Marketing companies comprising:
a communication device configured for:
receiving at least one user credential from at least one user device associated with at least one user;
transmitting at least one of at least one pre-selected portfolio company data and at least one training support data to the at least one user device;
receiving a first selected company data of the at least one pre-selected portfolio company data from the at least one user device;
receiving a first purchase order data associated with a first product of the first selected company data from the at least one user device;
transmitting the first purchase order data to a first server associated with the first selected company data;
receiving a first transaction profit data associated with the first purchase order data from the first server;
transmitting a purchase request to the at least one user device;
receiving a second selected company data of the at least one pre-selected portfolio company data and a second purchase order data from the at least one user device;
transmitting the second purchase order data associated with a product of the second selected company data to a second server associated with the second selected company data;
receiving a second transaction profit data associated with the second purchase order data from the second server; and
transmitting, using the communication device, at least one of the first transaction profit data, the second transaction profit data, and a subscription alert to the at least one user device;
a processing device configured for:
generating a user account based on the receiving of the user credentials;
analyzing at least one of the first transaction profit data and the at least one pre-selected portfolio company data to generate the purchase request; and
analyzing the first transaction profit data and the second transaction profit data to generate the subscription alert; and
a storage device is configured for retrieving at least one of the at least one pre-selected portfolio company data and the at least one training support data.

12. The system of claim 11, wherein the subscription alert informs the at least one user to upgrade a membership on the basis of the first transaction profit data and the second transaction profit data.

13. The system of claim 12, wherein the membership comprises a progressive schedule that allows the at least one user to pay for the membership upon reaching a predetermined milestone corresponding to at least one of a profit and an income.

14. The system of claim 11, wherein a second purchase order associated with the second purchase order data is fulfilled based on a reinvestment of at least a portion of fund corresponding to the first transaction profit data into the second product corresponding to the second selected company data.

15. The system of claim 13, wherein the communication device is further configured for receiving a sponsor data associated with a sponsor of the user account, wherein the sponsor is associated with the second selected company data, wherein the processing device is configured for:
determining a valid membership of the sponsor based on the sponsor data; and
fulfilling the second purchase order data associated with the second product of the second selected company data based on the determining of the valid membership of the sponsor.

16. The system of claim 15, wherein the determining of the valid membership is performed after a predetermined time-frame subsequent to the receiving of the second purchase order data.

17. The system of claim 15, wherein the communication device is configured for:
transmitting a plurality of validation requests to a plurality of user devices corresponding to a plurality of members above the sponsor in a hierarchy, wherein the transmitting of the plurality of validation requests is based on the determining of the valid membership; and
receiving a plurality of validation responses from the plurality of user devices, wherein the processing device is configured for validating the sponsor based on receiving of the plurality of validation responses within a predetermined timeframe.

18. The system of claim 11, wherein the first purchase order data comprises an alert configured to facilitate purchasing of the first product corresponding to the first selected company data.

19. The system of claim 11, wherein the communication device is further configured for:
transmitting a plurality of validation requests to a plurality of user devices corresponding to a plurality of members above the user account in a hierarchy; and
receiving a plurality of validation responses from the plurality of user devices, wherein the processing device is further configured for validating the user account comprising a Universal Resource Locator (URL) based on the receiving the plurality of validation responses within a predetermined timeframe.

20. The system of claim 19, wherein the plurality of validation requests corresponds to a milestone validation corresponding to the user account.
